(19) United States
(12) Patent Application Publication
(10) Pub. No.: US 2010/0260053 A1
(43) Pub. Date: Oct. 14, 2010

(54) PROCEDURES, SYSTEMS, APPARATUSES, AND COMPUTER PROGRAMS FOR PERFORMANCE MONITORING OF A PACKET CONNECTION

(75) Inventor: T. Benjamin Mack-Crane, Downers Grove, IL (US)

Correspondence Address: FITZPATRICK CELLA HARPER & SCINTO, 1290 Avenue of the Americas, NEW YORK, NY, 10104-3800, US

(73) Assignee: TELLABS OPERATIONS, INC., Naperville, IL (US)

(21) Appl. No.: 12/421,013

(22) Filed: Apr. 9, 2009

(51) Int. Cl. H04L 12/26; H04L 12/56

(52) U.S. Cl. 370/241.1; 370/252; 370/389

(57) ABSTRACT

Procedures, systems, apparatuses, and computer programs are disclosed for performance monitoring of a packet connection. In example embodiments, data is added to a performance monitoring packet at a network element, and the performance monitoring packet is then forwarded to an analysis element. Analysis of the data contained in performance monitoring packet may thereby be conducted at a location other than the receiving interface.

### BACKGROUND

1. Field

Example aspects of the present invention relate to performance monitoring of packet connections. More specifically, example aspects of the present invention relate generally to procedures, systems, apparatuses, and computer programs for performance monitoring of packet connections.

2. Description of Related Art

Networks with packet connections and packet communications may be used to connect a user of communication services to service providers and/or other users. In an example embodiment of a packet network, a data path is created by connecting two nodes via a channel on a communication line, such as a twisted pair or fiber optic cable. One node could be located, for example, at a user's end, with another node located at a service provider's location. The channel serves as the data path for packet communications between the user and service provider nodes.

Because two nodes of a network can be physically separated by long distances, a communication signal between nodes may degrade as it passes through a communication channel. Signal degradation may include loss of data packets and/or octets during transmission. Moreover, even if no substantial degradation is observed in the communication signal, the characteristics of the particular communication channel may add an undesirable delay in the communication of a data packet from one node to another node.

Performance monitoring of packet networks generally involves collecting information relating to the operation of a channel. This performance monitoring data may include, for example, the number of packets and/or octets sent from an originating node and the number of packet and/or octets received at a destination node. Such performance monitoring data may be on a cumulative basis and/or in a given time frame. The performance monitoring data may also include the time a packet is sent from an originating node and the time the packet is received at a destination node. Such performance monitoring information may be analyzed to assess the performance of a channel, for example, in terms of signal degradation (e.g., lost packets) and delay.

Performance monitoring implementations often include collecting performance monitoring data at an interface module of a network element. Other performance monitoring implementations often involve collecting performance monitoring data at a common control processor of a network element.

### SUMMARY

According to an example aspect of the present invention, a procedure of monitoring the performance of a packet connection is provided. The procedure includes adding information to a performance monitoring packet received at a network element, and routing the performance monitoring packet including the added information to an analysis element.

According to another example aspect of the present invention, a system is provided. The system comprises a first network element, a second network element, and an analysis element. The second network element is configured to receive a performance monitoring packet from the first network element, and add data to the performance monitoring packet. The second network element is also configured to route the performance monitoring packet to the analysis element.

According to still another example aspect of the present invention a computer program embodied in a computer-readable storage medium is provided. The program includes instructions which, when executed by a computer, cause the computer to perform a procedure that includes receiving a performance monitoring packet, adding information to the received performance monitoring packet, and providing routing information to the performance monitoring packet indicative of another computer.

According to yet another example aspect of the present invention, a data processing apparatus is provided, comprising at least one storage medium storing at least one program, as well as a processor coupled to the storage medium. The processor is arranged to execute the at least one program that (i) adds information to a received performance monitoring packet, and (ii) adds routing information indicative of another data processing apparatus to the performance monitoring packet.

According to a still further example aspect of the present invention, a procedure for analyzing performance of a packet connection between two network nodes is provided. The procedure includes receiving, at analysis element, a performance monitoring packet transmitted from a generating node to a target node, and extracting from the received performance monitoring packet at least one of a sending network element identifier, a sent packet count, a sent octet count, a received packet count, a received octet count, and a received time stamp. Information concerning at least one of signal degradation and delay is generated based on the extracted information.

These and other aspects of the present invention will be described in further detail below, with reference to the accompanying drawings.

### BRIEF DESCRIPTION OF THE DRAWINGS

FIG. 1 illustrates a network according to an example embodiment of the invention.

FIG. 2 illustrates a network according to another example embodiment of the invention.

FIG. 3 is a flow chart showing a procedure according to an example embodiment of the invention.

FIG. 4 is a logical diagram of modules which may be suitable for practicing one or more example embodiments of the invention.

FIG. 5 shows an example of a data processing architecture which may be suitable for practicing one or more example embodiments of the invention.

FIG. 6 is a flow chart showing a procedure according to another example embodiment of the invention.

### DETAILED DESCRIPTION

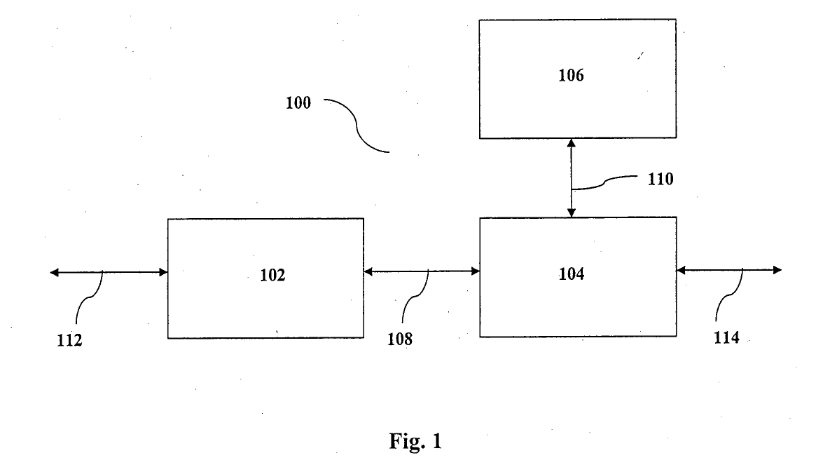

FIG. 1 illustrates a network 100 according to an example embodiment of the invention.

Network 100 includes network elements 102 and 104, as well as an additional element 106. Network elements 102 and 104 are connected by a channel 108. Network element 104 and element 106 are connected by a channel 110. Another channel 112 is provided to network element 102, and a further channel 114 is provided to network element 104. Thus, in the configuration depicted in FIG. 1, network elements 102 and 104 are “hops” on the network. As those skilled in the art will recognize, however, the network 100 may perform the functions described herein when configured in an alternative manner. For example, in an alternative configuration, network elements 102 and 104 could be endpoints on a network. As those skilled in the art will further recognize, network 100 may include any number of further elements communicating with network elements 102 and 104, as well as further elements communicating with element 106, including additional network elements along the channel 108 between network elements 102 and 104.

It should be noted that while channel 108 is configured in a point-to-point manner with network elements 102 and 104, the network could easily be reconfigured in a manner so that channel 108 connects multiple points to other multiple points. In such a case, the example embodiments of the invention described herein could be applicable to such a multipoint to multipoint channel, as well as to channels in a ring network, for performing aspects of performance monitoring such as delay measurement.

As is apparent from this description, the particular configuration selected for the network elements 102 and 104, element 106, and channels 108, 110, 112, and 114 may depend, in part, on the particular communication technology to be used with the network 100. To this end, the network 100 may be configured, for example, to support Ethernet, Multi Protocol Label Switching (MPLS), frame relay, Internet protocol (IP), user data protocol (UDP), X.25, Asynchronous Transfer Mode (ATM), Resource Reservation Protocol (RSVP), transmission control protocol (TCP), or other protocols and technologies. Moreover, network elements 102 and 104, and element 106 may take on a variety forms depending on the particular characteristics and configuration of network 100. In various example embodiments, the network elements may be switches, hubs, personal computers (PCs), laptop computers, printers, servers, routers, or any other facility or equipment used in conjunction with a telecommunications service.

Channels 108, 110, 112, and 114 may be configured to communicate information between the elements 102, 104, and 106. In specific example embodiments, the channels are used to communicate packet data signals between the elements. In such embodiments, the channels may be, for example, twisted pair cabling or fiber optic cables. In other example embodiments, the channels may represent wireless communication pathways, using technologies such as Wi-Fi. Those skilled in the art will recognize the channels may take on other forms in example embodiments.

In the example embodiment shown in FIG. 1, network element 102 acts to communicate a performance monitoring packet to network element 104 via channel 108. The performance monitoring packet may contain a variety of data. For example, the performance monitoring packet may include a sending point identifier. In cases where the performance monitoring packet originates at network element 102, the sending point identifier would be indicative of the network element 102. In other cases, wherein the performance monitoring packet originates at another element before being sent to network element 102 via channel 112, the sending point identifier would be indicative of the element from which the performance monitoring packet originated.

In some example embodiments, the performance monitoring packets could be operations, administration, and maintenance (OAM) packets in which the performance monitoring data is included. For example, the performance monitoring data could be included with Ethernet OAM or MPLS OAM packets in example embodiments.

The performance monitoring packet may also include a count of a number of packets and/or a number of octets sent by network element 102 on a cumulative basis and/or over a given time frame. Still further, the performance monitoring packet may include an indicator of the time that the performance monitoring packet is sent from the network element 102, i.e., a time stamp. Those skilled in the art will recognize that the performance monitoring packet may include either the count or time data, or include both the count and time data, and that the performance monitoring packet may include additional data as well.

The performance monitoring packet is routed to the network element 104 via channel 108. Once received by the network element 104, the performance monitoring packet may then be manipulated to include additional information. For example, the network element 104 may add an identifier indicative of the network element 104 to the performance monitoring packet, thereby designating that the performance monitoring packet was received by the network element 104. As another example, the network element 104 may add an indicator of the time that the network element 104 received the performance monitoring packet. As yet another example, the network element 104 may add a received packet count and/or a received octet count to the performance monitoring packet, indicating the number of packets and/or octets received by the network element 104 over a given period of time. More specifically, a received packet or octet count can be added by the network element 104 to the performance monitoring packet which corresponds to a time period indicated in the performance monitoring packet for which a sent packet or octet count is also included in the performance monitoring packet. As those skilled in the art will recognize, any combination of these examples of manipulations to the performance monitoring packet may be performed by the network element 104. Further, the network element 104 may act to perform additional manipulations to the data of performance monitoring packet.

The network element 104 also acts to route the performance monitoring packet to an element 106 via channel 110. In an example embodiment, the network element 104 modifies a routing address or connection label in the header of the performance monitoring packet to thereby forward the performance monitoring packet to the element 106. Thus, one of ordinary skill in the art will recognize that in example embodiments, a data plane forwarding mechanism that is already in place on the network element 104 may be used to provide the routing information to the performance monitoring packet.

As is apparent from FIG. 1, the element 106 may be a completely separate platform from the network element 104. That is, element 106 may be an element that is connected by a channel to an interface or common control processor of the network element 104. Thus, the element 106 may act as an analysis element and analyze the information content of the performance monitoring packet “off-line” of the network element 104. Alternatively, element 106 may be a separate component of network element 104, but distinct from the interface or common control processor of the network element.

In one example embodiment, the element 106 may include a computer located on the network 100. In another example embodiment, the element 106 may be part of a server platform located at a network management center. In such an embodiment, the element 106 could be configured to receive performance monitoring packets from different channels of a network, or further, performance monitoring packets from multiple networks. As is apparent from this disclosure, an operation system could be developed and incorporated with element 106 for processing and analyzing performance monitoring data in bulk at a low cost per connection monitored.

It should be noted that the channel 110 between network element 104 and the element 106 may use the same communication technology as the rest of network 100. In other embodiments, however, the channel 110 may use a form of communication to transport the performance monitoring packet from the network element 104 to the analysis element 106 that is different from communication technology used on the rest of network 100.

It should also be noted that the performance monitoring procedures described herein could be applied as part of a tandem monitoring technique. That is, the performance monitoring packets could be inserted and extracted from network elements that are hops, not endpoints of a network. As noted above, FIG. 1 generally depicts such a configuration.

A variety of analysis of packet connections may be performed based on the information in the performance monitoring packet received by the analysis element 106. For example, a comparison of a packet and/or octet count sent by network element 102 to a packet and/or octet count received by network element 104 that is included with the performance monitoring packet could be used to determine the loss of traffic between the network elements 102 and 104 on channel 108. As another example, time stamps added by the network elements 102 and 104 could be used to determine a transit time of the performance monitoring packet in channel 108. As a more specific example, a received time stamp included in a performance monitoring packet could be used to correlate performance measurements to selected time intervals (e.g., 15 minute and 24 hour intervals).

In alternative embodiments to FIG. 1, the actual analysis of the performance packet data could be conducted at an element other than the element depicted at 106. That is, element 106 could instead represent an intermediate point which receives the performance monitoring packet and then forwards the data to another element for analysis and processing.

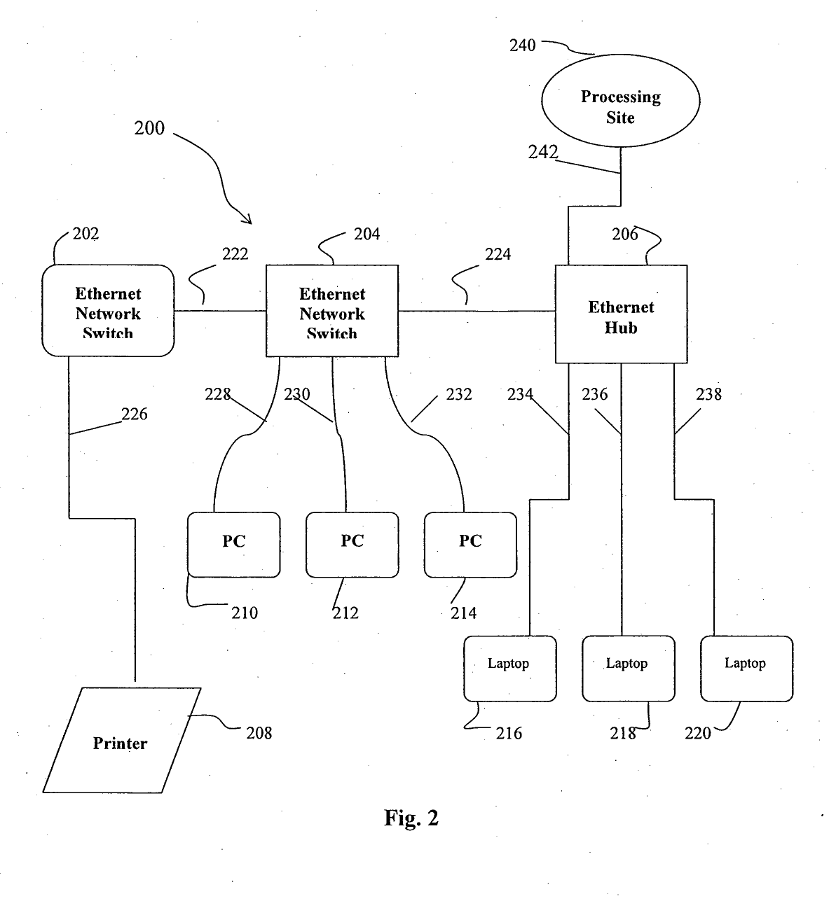

A more specific example embodiment of the invention is shown in FIG. 2, wherein a packet network 200 is depicted. In FIG. 2, network elements are depicted at references 202, 204, 206, 208, 210, 212, 214, 216, 218, and 220, and channels are depicted at references 222, 224, 226, 228, 230, 232, 234, 236, and 238. In this example embodiment, network devices, e.g., hubs, switches, servers, personal and laptop computers, and printers, are incorporated as the network elements, while fiber optic cables are placed at each of the channels. A network user, such as a service provider, could monitor performance aspects, such as traffic loss for each channel (number of packets and octets sent from a source node vs. number of packet and octets received at the end node) or time delay in the transmission of packets and octets sent (the time a packet is sent from a source node vs. the time at which it is received at a given end node). With this information, a user, such as a network administrator or service provider, may determine how to cost-effectively schedule network maintenance and/or assign network elements, channels, or any other network equipment.

In an example embodiment, a service provider or network administrator may desire to monitor performance between network element 202, an Ethernet switch, and network element 204, another Ethernet switch. Thus, a performance monitoring packet is generated at Ethernet switch 202. The performance monitoring packet includes performance monitoring data, such as the time the packet is sent or a sent packet count. The performance monitoring packet also includes an identifier specific to the Ethernet switch 202. The performance monitoring packet including the particular performance monitoring data may be generated using software implemented on the Ethernet switch 202, as will be more fully described below.

The performance monitoring packet generated at the Ethernet switch 202 is routed on channel 222 to the Ethernet switch 204. Upon receipt, the Ethernet switch 204 acts to manipulate the performance monitoring packet, for example, by adding a received packet count, or adding a time stamp indicating the time the performance monitoring packet is received by the Ethernet switch 204. The Ethernet switch 204 also adds an identifier indicative of the switch. The manipulation of the performance monitoring packet may be effectuated using software implemented on the Ethernet switch 204, as will be more fully described below.

The Ethernet switch 204 further acts to modify a routing address or connection label in the header of the performance monitoring packet, with the routing address or connection label specifying the processing site 240. Thus, the performance monitoring packet when sent by the Ethernet switch 204 is routed through channel 224, Ethernet hub 206, and channel 242 to processing site 240.

A processing site 240 is configured as an off-line performance analysis location. In this case, the performance monitoring packet sent by Ethernet switch 204 is received by the processing site 240 for analysis.

In assigning the location of processing site 240, the distances between the proposed processing site on a network, as well as the number of network elements, may be considered. For example, a user or a planning system may wish to have the processing site 240 a large distance from the network 200 in order to have a processing site 240 that is central to a plurality of networks other than network 200.

It is often the case that a network planner or service provider needs to consider factors in addition to the traffic characteristics of particular network elements. For example, certain links may be underutilized if routes are provisioned using optimizing algorithms or may be prone to failure due to the type of equipment or quality of the installation. Therefore, a network planner or service provider may consider other criteria, relating to, for example, type and cost of network components, length of network link, and materials composing the network link. A user, such as a network planner or service provider, may give particular consideration to these conditions, depending on how performance monitoring may be accurately transmitted and processed. It is contemplated that this allocation may vary, depending on the particular needs of a user and the characteristics of the packet network.

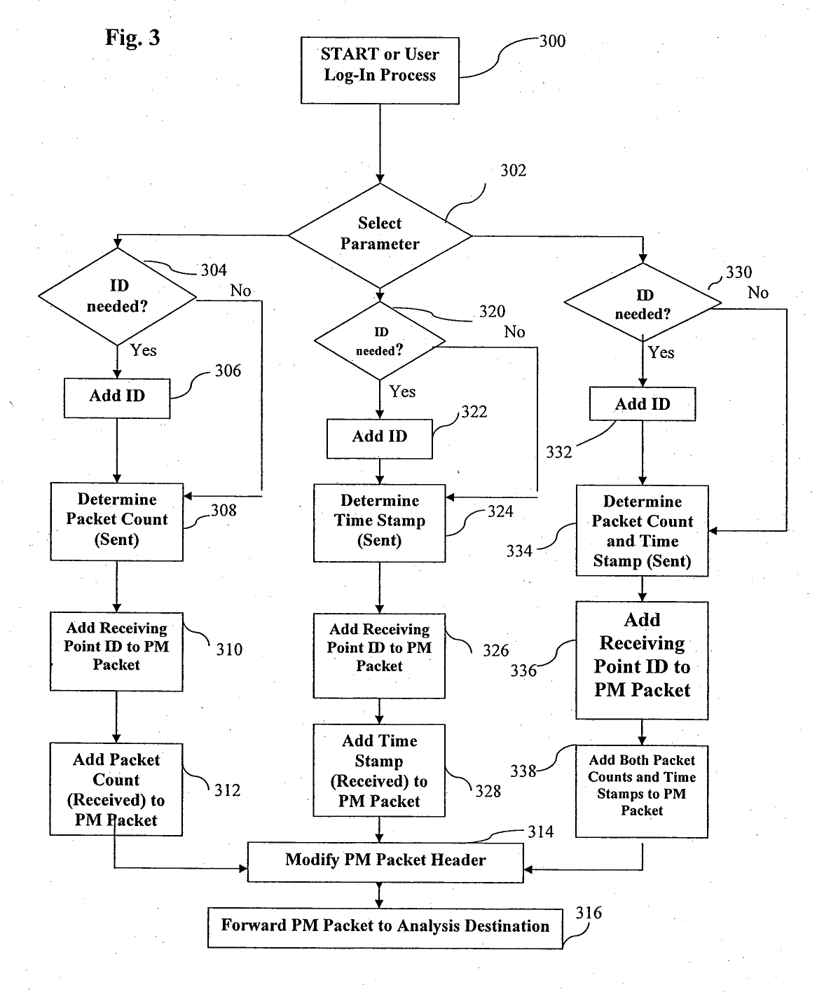

FIG. 3 illustrates blocks of a procedure for implementing performance monitoring in a packet network according to one example embodiment of the invention. This example embodiment makes use of a packet network where a user desires to test the network's performance when sending a packet from a source node to a destination node.

At block 300, the user initiates the performance monitoring process. Next, at block 302, the user selects which performance parameter is to be monitored. In the case where the user decides to monitor loss of traffic in the packet network, the network is checked, at block 304, to see if the particular connection includes multiple sending nodes, thereby necessitating the inclusion of sending identifiers of the nodes in the performance monitoring packets. If so, the sending identifications are added to the performance monitoring packets at block 306, for example, by the first network element 102, as described above. In the example embodiments of the invention that include a common analysis location for performance monitoring, the performance monitoring packets will need some sort of identifier of the channels being monitored.

At block 308, a packet and/or octet count which is sent from the originating node is determined and added to the performance monitoring packet. For example, the packet and/or octet count could be added by the first network element 102, as described above. The performance monitoring packet, now including the count of sent packets and/or octets, is routed on a channel toward a particular receiving point, such as the second network element 104, described above. The receiving point, at block 310, adds a receiving point identifier to the performance monitoring packet. A count of packets and/or octets received at the receiving point is also added to the performance monitoring packet at block 312. At block 314 the performance monitoring packet is further altered by modifying the header of the packet so as to include a destination address for the packet. The performance monitoring packet is then forwarded at block 316 to the destination wherein analysis will be performed, such as the analysis element 106, described above.

Referring again to FIG. 3, the user may determine, at block 302, to monitor a delay in packet transmission. If a user decides to monitor such a delay, the network is checked to see if there are multiple sending nodes at block 320, similar to block 306 described above. If so, a sending identifier is included in the performance monitoring packet at block 322.

At block 324, the time at which the performance monitoring packet is sent is added to the performance monitoring packet. The performance monitoring packet, including the time stamp, is then sent on a channel toward a particular receiving point. At the receiving point, in block 326, a receiving point identifier is added to the performance monitoring packet. Also at the receiving point, the time at which the performance monitoring packet was received is added to the performance monitoring packet in block 328. Finally, at blocks 314 and 316, the performance monitoring packet header is modified and the performance monitoring packet is forwarded to the destination where the performance analysis will take place using the data contained in the performance monitoring packet, as described above.

Referring yet again to FIG. 3, the user may determine, at block 330, to monitor multiple performance characteristics. For example, a user may choose to monitor both loss of traffic and delay in packet transmission. If a user decides to monitor both these aspects of packet transmission, the existence of multiple sending nodes is checked at block 328, similar to blocks 304 and 320. If multiple nodes are detected, a sending identifier is added at block 332 to a performance monitoring packet.

At block 332, a packet and/or octet count is determined and included in the performance monitoring packet. The time at which the performance monitoring packet is sent is also determined and added to the performance monitoring packet in block 334.

The performance monitoring packet, now including the count of packets and/or octets sent, as well as the time stamps, is routed on a channel toward a particular receiving point. At block 336, a receiving point identifier is added to the performance monitoring packet. Further, at block 338, a count of packets and/or octets received at the receiving point is added to the performance monitoring packet, and the time at which the performance monitoring packet was received is also added to the packet. Finally, at blocks 314 and 316, the performance monitoring packet header is modified and the performance monitoring packet is forwarded to the destination where the performance analysis will take place using the data contained in the performance monitoring packet, as described above.

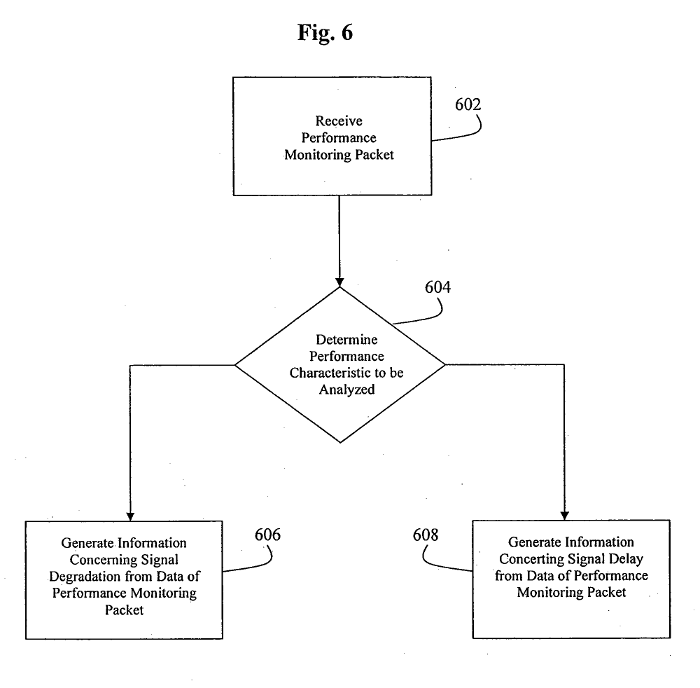

FIG. 6 illustrates blocks of a procedure for analyzing the data of a performance monitoring packet according to an example embodiment of the invention.

At block 602, a performance monitoring packet is received at the location where the analysis is to be conducted. The location could be, for example, the element 106 described above. After receiving the performance monitoring packet, at block 604 it is determined what performance characteristic is to be monitored. As described above, the performance characteristic could be signal degradation or delay of a packet connection. Of course, those skilled in the art will recognize other performance characteristics could be determined using the received performance monitoring characteristic.

If signal degradation is to be analyzed, at block 606 information concerning signal degradation is generated from data extracted from the received performance monitoring packet. This could be determined, for example, by comparing a sent packet or octet from a network element, such as network element 102 described above, to a packet or octet count received at a network element, such as network element 104 described above. To this end, network element identifiers could also be extracted from the data of the received performance monitoring packet to facilitate the analysis.

As another example, if signal delay is to be analyzed, at block 608 information concerning signal delay is generated from data extracted from the received performance monitoring packet. This could be determined, for example by comparing the time a packet or octet is sent from a network element such as network element 102 described above, to the time the packet or octet count is received at a network element, such as network element 104 described above (assuming that the clocks of the network elements are aligned, as is known in the art). To this end, network element identifiers could also be extracted from the data of the received performance monitoring packet to facilitate the analysis.

As is apparent to those skilled in the art, multiple performance characteristics could be analyzed using the data of performance monitoring packet received at block 602 shown in FIG. 6. For example, blocks 606 and 608 could be conducted simultaneously, or, as another example, blocks 604 and 606 could be conducted, followed by blocks 604 and 606.

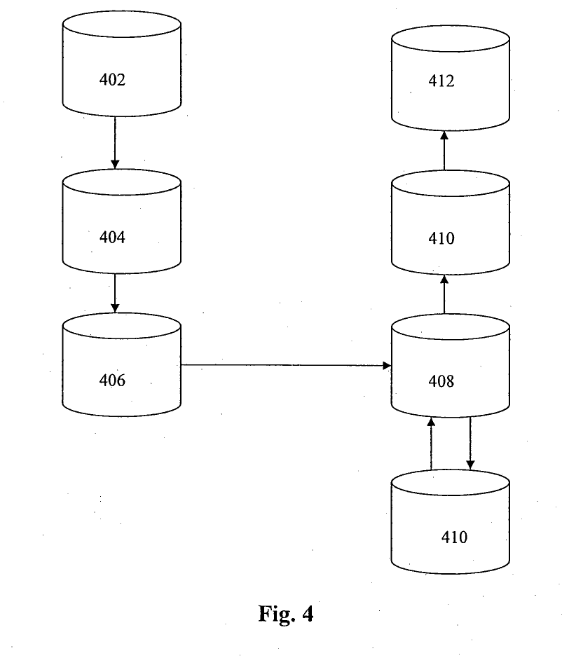

FIG. 4 is a logical diagram of modules in accordance with an example embodiment of the invention. The modules may be of a data processing system or device, which, according to example embodiments of the invention, can form individual ones of the components of the elements described. The modules may be implemented using hardcoded computational modules or other types of circuitry, or a combination of software and circuitry modules. The modules may perform processing according to the procedures described above.

Module 402 includes elements to either receive a performance monitoring packet, or generate a performance monitoring packet. Thus, module 402 may be, for example, a component of network element 102 described above. Module 404, which is associated with module 402, may include elements to manipulate the performance monitoring packet. Such manipulation may include adding data to the performance monitoring packet indicative of a sent packet and/or octet count, or a time stamp that the performance monitoring packet is sent using interface module 406. Such manipulation may further include addition of an identifier indicative of an element with which the module 406 is associated. Accordingly, modules 404 and 406 may also be components of network element 102 described above.

Module 408 represents another interface element, which may be, for example, a component of the network element 104 described above. Module 408, therefore, may receive the performance monitoring packet from module 406.

Module 408 is associated with module 410. The module 410 may include components to manipulate the performance monitoring packet, such as by adding data to the performance monitoring packet indicative of a received packet and/or octet count, or a time stamp that the performance monitoring packet is received at interface module 408. Module 410 may further include components to add an identifier to the performance monitoring packet indicative of the element with which module 410 is associated. For example, module 410 may include components that add an identifier of network element 404, as described above.

Module 410 represents another interface, which may be, for example, a component of the element 106 described above. The module 410 is associated with module 408 so to be capable of receiving the performance monitoring packet. The module 410 is also associated with module 412. The module 412 may include components to analyze the data contained in the performance monitoring packet.

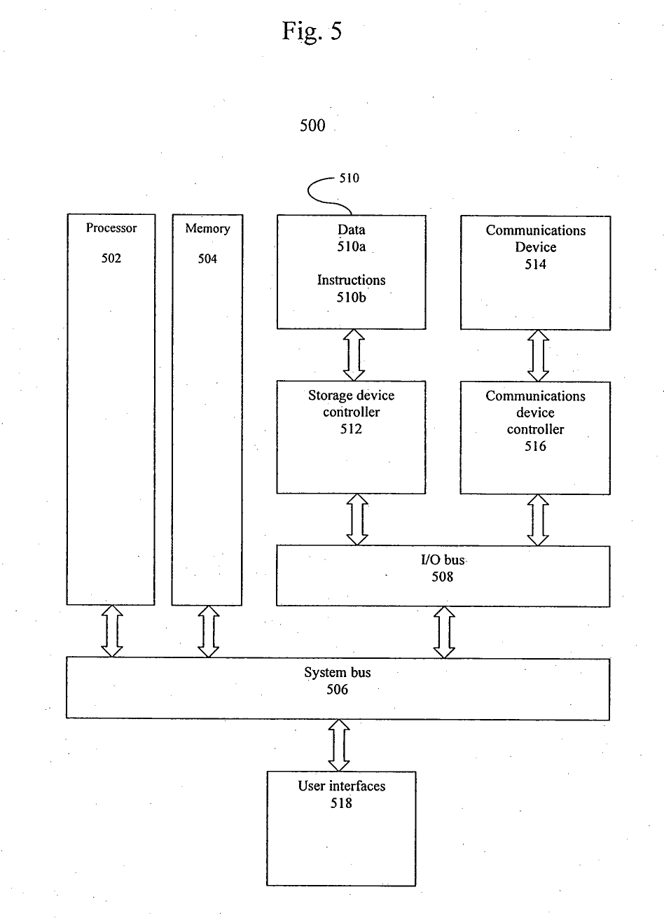

FIG. 5 is an architecture diagram of an example data processing system 500 which, according to an example embodiment of the invention, can form individual ones of the network elements 102 and 104, as well as element 104 shown in FIG. 1, or further, the more specific components shown in FIG. 2. Data processing system 500 includes a processor 502 coupled to a memory 504 via system bus 506. Processor 502 is also coupled to external Input/Output (I/O) devices (not shown) via the system bus 506 and an I/O bus 508, and at least one input/output user interface 518. Processor 502 may be further coupled to a communications device 514 via a communications device controller 516 coupled to the I/O bus 508. Processor 502 uses the communications device 514 to communicate with a network, such as, for example, the networks 100 and 200 shown in FIGS. 1 and 2. In example embodiments, device 514 has a data port operably coupled to a network for sending and receiving data, such as a twisted pair cabling port, fiber optic cable port, or a port supporting wireless communication. It is noted, however, that the device 514 may also have one or more additional input and output ports. A storage device 510 having a computer-readable medium is coupled to the processor 502 via a storage device controller 512 and the I/O bus 508 and the system bus 506. The storage device 510 is used by the processor 502 and controller 512 to store and read/write data 510a, and to store program instructions 510b used to implement the procedures described above. The storage device 510 also stores various routines and operating programs (e.g., Microsoft Windows, UNIX/LINUX, or OS/2) that are used by the processor 502 for controlling the overall operation of the system 500. At least one of the programs (e.g., Microsoft Winsock) stored in storage device 510 can adhere to TCP/IP protocols (i.e., includes a TCP/IP stack), for implementing a known procedure for connecting to the Internet or another network.

In operation, processor 502 loads the program instructions 510b from the storage device 510 into the memory 504. Processor 502 then executes the loaded program instructions 510b to perform any of the example procedures described above, for operating the system 500.

In example embodiments, the instructions 510b stored in the storage device 510 include instructions which, when executed by the processor 502, enable the network elements 102 and 104 to perform the manipulations on the performance monitoring packets described above.

Although this invention has been described in certain specific example embodiments, many additional modifications and variations would be apparent to those skilled in the art. It is therefore to be understood that this invention may be practiced otherwise than as specifically described. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention. Components described as software executing on a processor can be implemented as hardware circuits or a combination of hardware and software. Thus, the present embodiments of the invention should be considered in all respects as illustrative and not restrictive, the scope of the invention to be determined by any claims supportable by this application and the claims' equivalents rather than the foregoing description.

FIGS. 3 and 6 are flow charts illustrating procedures according to an example embodiment of the invention. The techniques illustrated in these figures may be performed sequentially, in parallel or in an order other than that which is described. It should be appreciated that not all of the techniques described are required to be performed, that additional techniques may be added, and that some of the illustrated techniques may be substituted with other techniques.

Software embodiments of the present invention may be provided as a computer program product, firmware, or software, that may include an article of manufacture on a machine accessible or machine readable medium (memory) having instructions. The instructions on the machine accessible or machine readable medium may be used to program a computer system or other device. The machine-readable medium may include, but is not limited to, floppy diskettes, optical disks, flash drives, CD-ROMs, and magneto-optical disks or other types of media/machine-readable medium suitable for storing electronic instructions. The techniques described herein are not limited to any particular software configuration. They may find applicability in any computing or processing environment. The terms “machine accessible medium,” “computer readable medium” or “machine readable medium” include any medium that is capable of storing, encoding, or embodying a sequence of program code or instructions for execution by the machine and that cause the machine to perform any one of the procedures described herein. Furthermore, it is common in the art to speak of software, in one form or another (e.g., program, procedure, process, application, module, unit, logic, code, and so on) as taking an action or causing a result. Such expressions are merely a shorthand way of stating that the execution of the software by a processing device causes the processor to perform an action in order to produce a result. In other embodiments, functions performed by software can instead be performed by hardcoded modules. Therefore, the invention is not limited only for use with stored software programs.

In addition, it should be understood that the figures illustrated in the drawing sheets, which highlight example functional aspects and uses of the present invention, are presented for example purposes only. The architectural aspects of the present invention are sufficiently flexible and configurable, such that it may be utilized (and navigated) in ways other than that shown in the accompanying figures.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the procedures recited in the claims need not be performed in the order presented.

What is claimed is:

1. A procedure of monitoring performance of a packet connection comprising:
adding information to a performance monitoring packet received at a network element; and
routing the performance monitoring packet including the added information to an analysis element.

2. A procedure according to claim 1, wherein the added information includes at least one of a network element identifier, a received packet count, a received octet count, and a received time stamp.

3. A procedure according to claim 1, wherein the analysis element is connected to the network element by a channel.

4. A procedure according to claim 1, wherein the routing comprises modifying the header of the performance monitoring packet to include a routing address or connection label of the analysis element.

5. A procedure according to claim 1, furthering comprising analyzing the performance monitoring packet received at the analysis element.

6. A procedure according to claim 1, wherein the performance monitoring packet is generated at a hop on a network.

7. A procedure according to claim 1, wherein the network element is a hop on a network.

8. A procedure according to claim 1, wherein the performance monitoring packet is an operation, administration, and maintenance packet.

9. A system comprising:
a first network element;
a second network element; and
an analysis element,
wherein the second network element is configured to receive a performance monitoring packet from the first network element, configured to add data to the performance monitoring packet, and configured to route the performance monitoring packet to the analysis element.

10. A system according to claim 9, wherein the data added to the performance monitoring packet by the second network element includes at least one of a second network element identifier, a received packet count, a received octet count, and a received time stamp.

11. A system according to claim 9, wherein at least one of the first and second network elements is a hop on a network.

12. A system according to claim 9, wherein at least one of the first and second network elements is an endpoint node of a network.

13. A system according to claim 9, wherein the analysis element is a physically separated element from the second network element, and the analysis element is connected to the second network element by a channel.

14. A system according to claim 9, wherein the analysis element is configured to receive performance monitoring packets from a plurality of network elements.

15. A data processing apparatus, comprising:
at least one storage medium storing at least one program; and
a processor coupled to the storage medium and arranged to execute the at least one program to (i) add information to a received performance monitoring packet, and (ii) add routing information indicative of another data processing apparatus to the performance monitoring packet.

16. The data processing apparatus of claim 15, wherein the information added to the performance monitoring packet includes at least one of an identifier of the data processing apparatus, a received packet count, a received octet count, and a received time stamp.

17. A procedure for analyzing performance of a packet connection between two network nodes, comprising:
receiving, at an analysis element, a performance monitoring packet transmitted from a generating node to a target node;
extracting from the received performance monitoring packet at least one of a sending network element identifier, a sent packet count, a sent octet count, a received packet count, a received octet count, and a received time stamp; and
generating information concerning at least one of signal degradation and delay of the packet connection based on the extracted information.
